(19) United States
(12) Patent Application Publication
(10) Pub. No.: US 2025/0353668 A1
(43) Pub. Date: Nov. 20, 2025

(54) FOOT OPERATED LID OPENER FOR WASTE RECEPTACLES

(71) Applicants: Miranda Hampton, Calgary (CA); Greig Hampton, Calgary (CA)

(72) Inventors: Miranda Hampton, Calgary (CA); Greig Hampton, Calgary (CA)

(21) Appl. No.: 19/201,985

(22) Filed: May 8, 2025

Related U.S. Application Data
(60) Provisional application No. 63/647,642, filed on May 15, 2024.

(51) Int. Cl. B65F 1/16

(52) U.S. Cl. CPC B65F 1/163; B65F 1/1646

(57) ABSTRACT

A foot operated lid opener device for a waste receptacle having a hinged lid a has a foot lever that is pivotally attached to an interior side of a sidewall of the waste receptacle. A linkage having a dog-leg member that extends in a direction toward the lid and that terminates at a free end, the free end configured to make rolling contact with an underside of the lid. A connecting rod is pivotally attached at one end to the foot lever and is pivotally attached to a link of the linkage, such that depressing the foot lever causes the dog-leg member to move in a direction that lifts the lid.

### CROSS-REFERENCE TO RELATED APPLICATIONS

This application claims the benefit of U.S. Provisional Patent Application Ser. No. 63/647,642, filed May 15, 2024, the entirety of which is incorporated herein by reference.

### FIELD OF THE INVENTION

The present invention relates to waste receptacles and, more particularly, relates to a foot operated device for the hands-free lifting of a waste receptacle lid.

### BACKGROUND OF THE INVENTION

Waste receptacles, such as those found in municipal parks, often have lids that must be raised to deposit waste into a trash bin located within the receptacle. It is undesirable to lift the lid with one's hands because the lid is often soiled. Accordingly, there is a need and a desire for a foot operated lid lifting device that can be installed on existing waste receptacles as a retrofit installation and which can also be installed on new waste receptacles.

### SUMMARY OF THE INVENTION

Embodiments of the invention provide for a foot operated lid lifting device that can be retrofitted to an existing waste receptacle without extensive modification to the receptacle and without shortening the lifespan of the receptacle through corrosion or wear.

Embodiments of the invention provide for a foot operated lid lifting device that has a low-profile configuration.

Embodiments of the invention provide for a foot operated lid lifting device that can be installed on new waste receptacles.

Embodiments of the invention provide a foot operated lid lifting device that is easily operated.

Embodiments of the invention provide a foot operated lid lifting device that is easy to manufacture.

In one aspect, a foot operated lid opener device for a waste receptacle having a hinged lid is disclosed. The device has a foot lever that is pivotally attached to an interior side of a sidewall of the waste receptacle. A linkage having a dog-leg member that extends in a direction toward the lid and that terminates at a free end, the free end configured to make rolling contact with an underside of the lid. A connecting rod is pivotally attached at one end to the foot lever and is pivotally attached to a link of the linkage, such that depressing the foot lever causes the dog-leg member to move in a direction that lifts the lid.

In another aspect, the linkage may have a first link, a second link, and a third link. The first link may be supported for rotation relative to the sidewall. The second link may be supported for rotation relative to the sidewall. The third link may be pivotally attached at one end to the first link and may be pivotally attached at an opposite end to the second link. The connecting rod may be pivotally attached to the first link. The third link may have the dog-leg member.

In another aspect, the first link may be pivotally attached to the sidewall to rotate relative to the sidewall. The second link may be pivotally attached at one end to the sidewall to rotate relative to the sidewall.

In another aspect, the first link may be triangular shaped and may have three apexes. The pivotal connection of the first link and the sidewall may be at a first apex. The pivotal connection of the third link and the first link may be at a second apex. The pivotal connection of the first link and the connecting rod may be at a third apex.

Numerous additional objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be made to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 is a diagrammatic illustration of a conventional waste receptacle in connection with a foot-actuated lid opener constructed in accordance with the principles of an embodiment of the invention;

FIG. 2 is a diagrammatic illustration of a conventional waste receptacle in connection with a foot-actuated lid opener constructed in accordance with the principles of an embodiment of the invention;

FIG. 3 is a diagrammatic perspective illustration of a foot-actuated lid opener constructed in accordance with the principles of an embodiment of the invention;

FIG. 4 is another diagrammatic perspective illustration of a foot-actuated lid opener constructed in accordance with the principles of an embodiment of the invention;

FIG. 5 is a diagrammatic perspective illustration of a foot-actuated lid opener constructed in accordance with the principles of an embodiment of the invention and shown in use in connection with a waste receptacle that is partially shown for clarity; and

FIG. 6 is another diagrammatic perspective illustration of a foot-actuated lid opener constructed in accordance with the principles of an embodiment of the invention and shown in use in connection with a waste receptacle that is partially shown for clarity.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

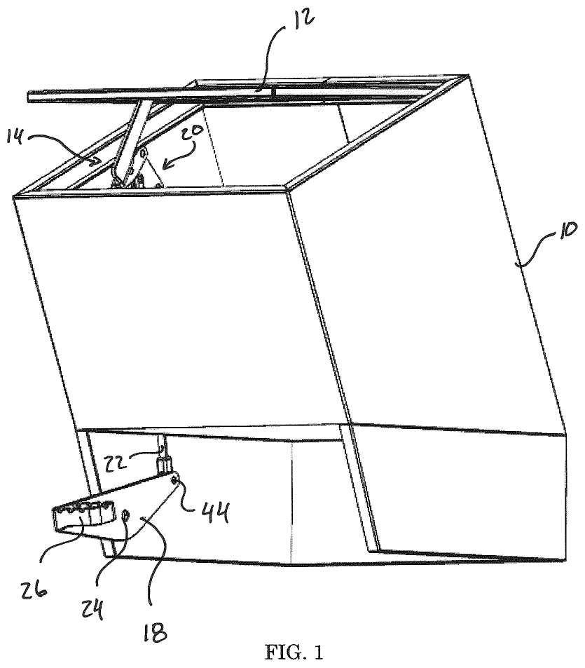

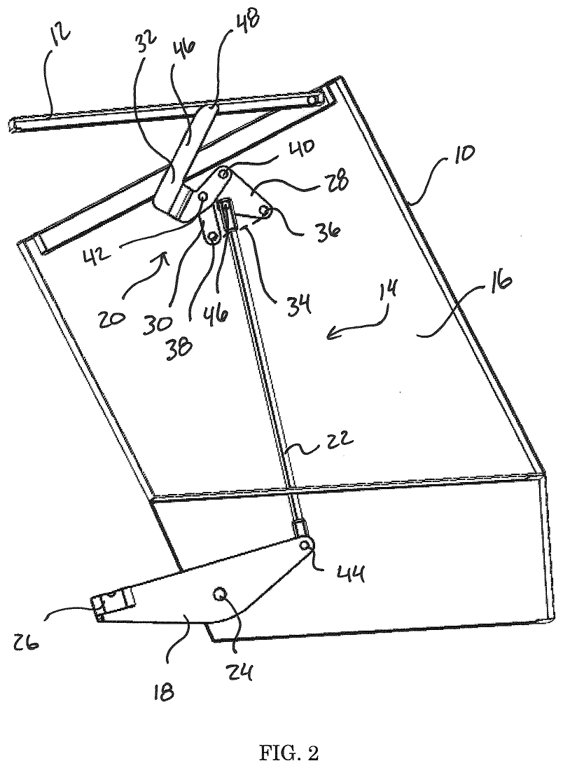

In FIGS. 1-2 there are shown diagrammatic illustrations of a conventional waste receptacle 10 having a rotating lid 12. Further illustrated is a device 14 that is mounted to the waste receptacle 10 and configured to lift the lid 12 to allow one to deposit waste into a bin (not shown) that is located within the interior of the waste receptacle by using one's foot as opposed to his/her hand to lift the lid. While device 14 is illustrated as being attached to one side of receptacle 10, the device can be mirrored for attachment to the opposite side of the receptacle.

Device 14 is configured to be attached to sidewall 16 of the waste receptacle on the interior side thereof and is further configured to be located between the interior side and the waste bin that is located within the interior of the waste receptacle.

As shown, device 14 includes a foot lever 18, a four-bar linkage 20, and a connecting rod 22. The foot lever 18 is pivotally attached to the bottom of the sidewall 16 by coupling 24, which can be as simple as a threaded fastener extending through the sidewall and a cooperating hole formed in the foot lever that is secured by a nut. As further shown, foot lever 18 is connected to the sidewall 16 with a forward portion thereof having a foot pad 26 disposed exteriorly and at a front of the waste receptacle 10. A back portion of the foot lever 18 is disposed in the interior of the waste receptacle.

The four-bar linkage 20 comprises a first link 28, a second link 30, and third link 32, and forth link provided by the sidewall 16 between connection points of the first and second links with the sidewall as represented by dashed line 34. As representatively shown, the first link 28 may be triangular shaped and is pivotally attached to the sidewall 16 by a coupling 36 that is located at a first apex location. The second link 30 may be straight and is pivotally attached at one end to the sidewall 16 by a coupling 38. The third link 32 is pivotally attached at one end to the first link 28 by a coupling 40 that is located at a second apex location on the first link and is pivotally attached at an opposite end to the second end of the second link 30 by a coupling 42.

As further shown, the connecting rod 22 is pivotally connected at one end by a coupling 44 to the foot lever 18 to the back portion thereof and is pivotally connected at an opposite end to the first link 28 by a coupling 46 that is located at a third apex location on the first link.

Couplings 36, 38, 40, 42, and 44 can be any type of coupling that provides a pivotal connection between the respective links. As a nonlimiting example, the couplings could be pressed fasteners, such as rivets, or could comprise threaded fasteners secured by nuts.

As will be further described in detail below, the third link 32 has an upstanding, offset dog-leg member 46 having a free end 48 that makes a rolling contact with an underside surface of the lid 12 at an interiorly disposed location in relation to the side of the lid adjacent to the sidewall to which device 10 is attached. The rolling contact minimizes sliding friction between the free end 48 and the underside of lid 12 and the resultant surface wear to both components. As shown, and in aspects, the dog-leg member 46 is not physically attached to the lid 12 and is only abutted against the lid by the weight of the lid bearing against the dog-leg member. As such, the lid may be lifted away from the dog-leg member 46 for instance when the interior trash bin needs to be removed or if one does not want to use device 10 to lift the lid.

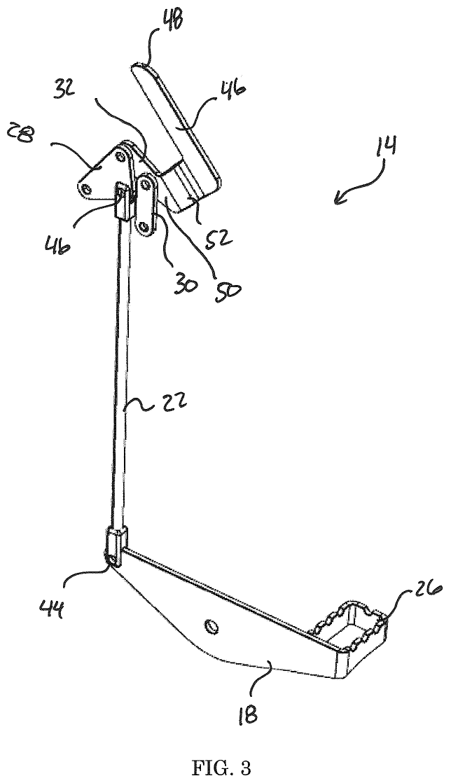

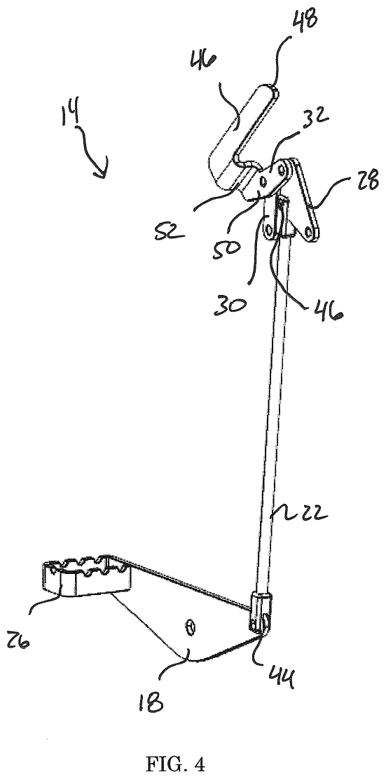

In FIGS. 3 and 4 there are shown diagrammatic views of device 10 unattached from the waste receptacle which further illustrate the components comprising the device. As seen here, the third link 32 has a first portion 50 of a generally planar shape to which the first and second links are pivotally attached. The upstanding, offset dog-leg member 46 is located offset from the first portion 50 in an interior direction therefrom and is connected to the first portion by a bridge portion 52 that extends between the first portion and the dog-leg member. Offsetting the dog-leg member 46 from the first portion 50 of the third link 32 allows the dog-leg member to clear a lip that may be present at the top opening of the waste receptacle while allowing the other links to be located juxtaposed to the interior side of the sidewall to which device 10 is attached.

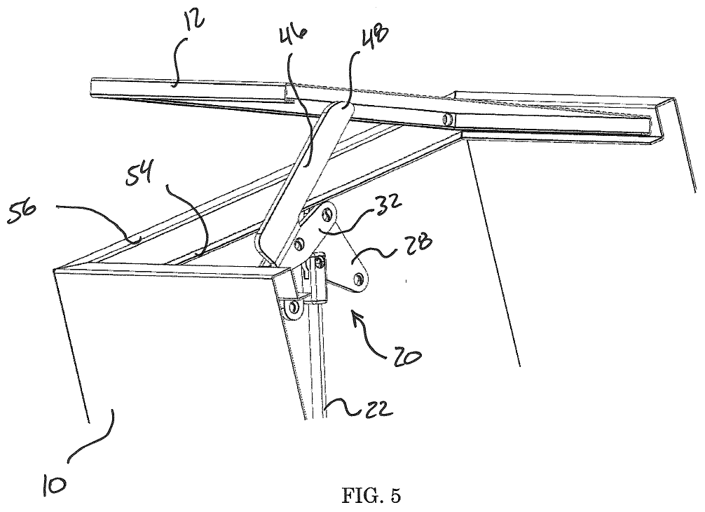

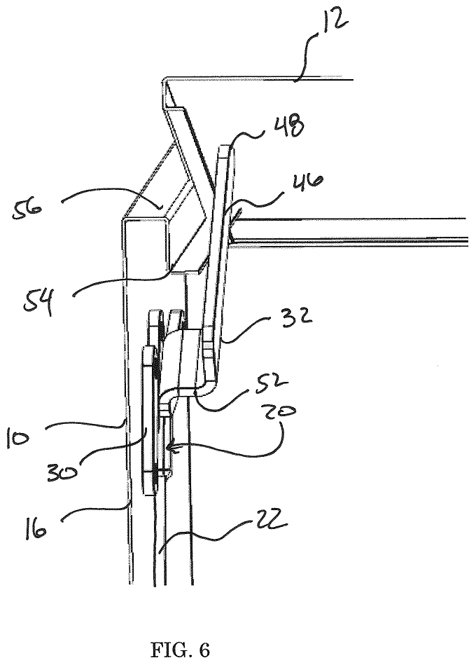

In FIGS. 5 and 6 there are shown diagrammatic views of device 10 attached to the waste receptacle 10 with the receptacle partially shown for clarity. As further seen here, the dog-leg member 46 of the third link 32 is offset and clears lip 54 at the open end 56 of the receptacle with the remaining elements of device 10 may be tucked back under the lip. This provides a low-profile configuration of device 10 such that it does not interfere with the waste bin (not shown) located within the receptacle. As shown is the rolling contact between the dog-leg member 46 and the bottom side of the lid 12.

In operation, one can simply step on the foot pad of the foot lever 14 to lift the lid 12 to allow access to the waste receptacle 10. Stepping on foot lever 14 causes the lever to rotate about coupling 24, lifting its back portion which in turn lifts the connecting rod 22. The connecting rod 22, connected to the first link 28, when lifted causes movement in the four-bar linkage 20 such that the third link 32 is rotated relative to the waste receptacle 10 which in turn causes the dog-leg member 46 rotates from a lowered position into a raised position, while the free end 48 rolls against the underside of the lid 12 to minimize sliding friction, thereby lifting or raising the lid. The radius of end 48 is designed so that it rolls against the lid as it rotates and moves up and towards the lid hinge.

Although the invention has been described by reference to specific embodiments, it should be understood that numerous changes may be made within the spirit and scope of the inventive concepts described.

What is claimed is:

1. A foot operated lid opener device for a waste receptacle having a hinged lid, the device comprising:
a foot lever pivotally attached to an interior side of a sidewall of the waste receptacle;
a linkage, the linkage having a dog-leg member that extends in a direction toward the lid and terminating at a free end, the free end configured to make rolling contact with an underside of the lid; and
a connecting rod pivotally attached at one end to the foot lever and pivotally attached to a link of the linkage, such that depressing the foot lever causes the dog-leg member to move in a direction that lifts the lid.

2. The foot operated lid opener device of claim 1, wherein the dog-leg member is not connected to the lid such that the lid can be moved away from the dog-leg member.

3. The foot operated lid opener device of claim 1, wherein the connecting rod extends between the foot lever and the linkage along the interior side of the sidewall of the receptacle.

4. A foot operated lid opener device for a waste receptacle having a hinged lid, the device comprising:
a foot lever pivotally attached to an interior side of a sidewall of the waste receptacle;
a linkage having a first link, a second link, and a third link;
the first link supported for rotation relative to the sidewall;
the second link supported for rotation relative to the sidewall;
the third link pivotally attached at one end to the first link and pivotally attached at an opposite end to the second link;
a connecting rod pivotally attached at one end to the foot lever and pivotally attached at an opposite end to the first link; and
the third link having a dog-leg member extending in a direction toward the lid and terminating at a free end that is configured make rolling contact with an underside of the lid, such that depressing the foot lever causes the dog-leg member to move in a direction that lifts the lid.

5. The foot operated lid opener device of claim 4, further comprising:
a foot pad on an end of the foot lever that is disposed exteriorly of a front of the waste receptacle.

6. The foot operated lid opener device of claim 4, wherein the dog-leg member is not connected to the lid such that the lid can be moved away from the dog-leg member.

7. A foot operated lid opener device for a waste receptacle having a lid, the device comprising:
a foot lever pivotally attached to an interior side of a sidewall of the waste receptacle, the foot lever having a foot pad which is disposed exteriorly of a front of the waste receptacle;
a linkage having a first link, a second link, and a third link;
the first link pivotally attached to the sidewall;
the second link pivotally attached at one end to the sidewall;
the third link pivotally attached at one end to the first link and pivotally attached at an opposite end to a second end of the second link;
a connecting rod pivotally attached at one end to the foot lever and pivotally attached at an opposite end to the first link; and
the third link having a dog-leg member extending in a direction toward the lid and terminating at a free end that is configured make rolling contact with an underside of the lid.

8. The foot operated lid opener device of claim 7, wherein the first link is triangular shaped having three apexes, and further wherein the pivotal of the first link and the sidewall is at a first apex, the pivotal connection of the third link and the first link is at a second apex, and the pivotal connection of the first link and the connecting rod is at a third apex.

9. The foot operated lid opener device of claim 7, wherein:
the third link has a first portion that is planar shaped, the first link is pivotally attached to the first portion, and the second link pivotally attached to the first portion; and
the dog-leg member being offset from the first portion and connected with the first portion by a bridge portion extending between the dog-leg member and the first portion.

10. The foot operated lid opener device of claim 7, wherein the dog-leg member is not connected to the lid such that the lid can be moved away from the dog-leg member.
